(19) United States
(12) Patent Application Publication
(10) Pub. No.: US 2026/0285771 A1
(43) Pub. Date: Sep. 24, 2026

(54) COMPOSITE STRUCTURES AND ASSOCIATED METHODS

(71) Applicant: Battelle Energy Alliance, LLC, Idaho Falls, ID (US)

(72) Inventors: Arin S. Preston, Idaho Falls, ID (US); Jorgen F. Rufner, Idaho Falls, ID (US)

(21) Appl. No.: 19/573,633

(22) Filed: Mar. 20, 2026

Related U.S. Application Data
(60) Provisional application No. 63/775,434, filed on Mar. 21, 2025.

(51) Int. Cl. C04B 37/00; C04B 41/45; C04B 41/88

(52) U.S. Cl. CPC C04B 37/001; C04B 41/4545; C04B 41/88; C04B 2237/76

(57) ABSTRACT

A composite structure includes a first brittle core structure and supportive surrounding structure with a bond formed between the first brittle core structure and the supportive surrounding structure. The composite structure is formed by positioning an outer material in a cavity of a sintering device. Then depositing an inner material in the outer material. Then applying a pressure to the outer material and the inner material, and heating the outer material and the inner material to a sintering temperature of at least one of the outer material and the inner material while applying the pressure.

### CROSS-REFERENCE TO RELATED APPLICATIONS

This application claims the benefit under 35 U.S.C. § 119(e) of U.S. Provisional Patent Application Ser. No. 63/775,434, filed Mar. 21, 2025, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

Composite structures are disclosed. More specifically, composite structures having high hardness cores surrounded by a supportive structure and associated methods are disclosed.

### BACKGROUND

Materials having high hardness, such as ceramic materials, are often used for various shielding structures, such as thermal shielding structures, radiation shielding structures, kinetic impact shielding structures, among others. Ceramic materials are inorganic, non-metallic solid materials. Structures formed from ceramic materials are conventionally shaped and hardened by heating them to high temperatures. Other high hardness materials may be formed through similar processes. Ceramics are versatile because they are generally hard, light weight, insulative, and resistant to chemical reactions and corrosion, making them desirable for many different applications. Ceramic materials are also electrically insulative, such that they may be used in electrical systems, electronic systems, and other electronic or microelectronic devices.

### SUMMARY

Embodiments of the disclosure include a composite structure. The composite structure includes a first brittle core material. The composite structure further includes a fiber reinforced composite material radially surrounding the first brittle core material. The composite structure also includes a chemical bond between a radially outer surface of the first brittle core material and a radially inner surface of the fiber reinforced composite material.

Another embodiment of the disclosure incudes a method of forming a composite structure. The method includes positioning an outer material in a cavity of a sintering device. The method further includes depositing an inner material in the outer material. The method also includes applying a pressure to the outer material and the inner material. The method further includes heating the outer material and the inner material to a sintering temperature of at least one of the outer material and the inner material while applying the pressure, the inner material exhibiting a higher hardness than the outer material after applying the pressure and heating the outer material and the inner material.

Other embodiments of the disclosure include a method of forming a composite structure. The method includes depositing a first base material powder into a cavity of a sintering assembly. The method further includes depositing a sintered ceramic structure over the first base material powder. The method also includes depositing a second base material powder over the sintered ceramic structure. The method further includes applying a pressure to the first base material powder, the sintered ceramic structure, and the second base material powder within the cavity. The method also includes heating the first base material powder, the sintered ceramic structure, and the second base material powder within the cavity to a sintering temperature of the first base material powder and the second base material powder while applying the pressure.

### BRIEF DESCRIPTION OF THE DRAWINGS

While the specification concludes with claims particularly pointing out and distinctly claiming embodiments of the present disclosure, the advantages of embodiments of the disclosure may be more readily ascertained from the following description of embodiments of the disclosure when read in conjunction with the accompanying drawings in which:

FIG. 1 illustrates a perspective view of a composite base structure, in accordance with embodiments of the disclosure;

FIG. 2 illustrates a perspective view of a base assembly including the composite base structure of FIG. 1, in accordance with embodiments of the disclosure;

FIG. 3 illustrates a sintering assembly including the base assembly of FIG. 2, in accordance with embodiments of the disclosure;

FIG. 4 illustrates a perspective view of a composite structure formed by the sintering assembly of FIG. 3, in accordance with embodiments of the disclosure;

FIG. 5 illustrates an exploded perspective view of a base assembly, in accordance with embodiments of the disclosure;

FIG. 6A illustrates a perspective view of a composite structure formed from the base assembly of FIG. 5, in accordance with embodiments of the disclosure;

FIG. 6B illustrates a sectional view of the composite structure of FIG. 6A, in accordance with embodiments of the disclosure;

FIGS. 7A-7D illustrate simplified schematic views of a sintering assembly during different process stages for forming a composite structure, in accordance with embodiments of the disclosure;

FIG. 8 illustrates an enlarged perspective view of a composite base structure, in accordance with embodiments of the disclosure;

FIG. 9 illustrates a plan view of a composite base structure, in accordance with embodiments of the disclosure; and

FIG. 10 illustrates an enlarged perspective view of a composite structure, in accordance with embodiments of the disclosure.

### DETAILED DESCRIPTION

The following description provides specific details, such as material compositions, shapes, and sizes, in order to provide a thorough description of embodiments of the disclosure. However, a person of ordinary skill in the art would understand that the embodiments of the disclosure may be practiced without employing these specific details. Indeed, the embodiments of the disclosure may be practiced in conjunction with conventional techniques employed in the industry.

Drawings presented herein are for illustrative purposes only, and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the terms “configured” and “configuration” refers to a size, a shape, a material composition, a material distribution, orientation, and arrangement of at least one feature (e.g., one or more of at least one structure, at least one material, at least one region, at least one device) facilitating use of the at least one feature in a pre-determined way.

As used herein, the term “substantially” in reference to a given parameter means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” in reference to a numerical value for a particular parameter is inclusive of the numerical value and a degree of variance from the numerical value that one of ordinary skill in the art would understand is within acceptable tolerances for the particular parameter. For example, “about” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, relational terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the drawings. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, the term “and/or” means and includes any and all combinations of one or more of the associated listed items.

As used herein, the terms “vertical,” “longitudinal,” “horizontal,” and “lateral” are in reference to a major plane of a structure and are not necessarily defined by earth's gravitational field. A “horizontal,” “longitudinal,” or “lateral” direction is a direction that is substantially parallel to the major plane of the structure, while a “vertical” direction is a direction that is substantially perpendicular to the major plane of the structure. The major plane of the structure is defined by a surface of the structure having a relatively large area compared to other surfaces of the structure. With reference to the drawings, a “horizontal,” “longitudinal,” or “lateral” direction may be perpendicular to an indicated “Z” axis, and may be parallel to an indicated “X” axis and/or parallel to an indicated “Y” axis; and a “vertical” direction may be parallel to an indicated “Z” axis, may be perpendicular to an indicated “X” axis, and may be perpendicular to an indicated “Y” axis.

As used herein, the terms “electrical field assisted sintering” (EFAS) and “spark plasma sintering” (SPS) are equivalent terms that may be used interchangeably.

As used herein the term “brittle” means and includes a material having a high hardness and a low fracture toughness. Brittle materials may include ceramic materials, such as silicon carbide (SiC), boron carbide (B₄C), titanium carbide (TiC), tungsten carbide (WC), alumina (Al₂O₃), zirconia (ZrO₂), silica (SiO₂), magnesia (MgO), lime (CaO), silicon nitride (Si₃N₄), etc., and metals having a high hardness, such as beryllium, bismuth, chromium, gallium, manganese, silicon, boron, germanium, tungsten carbides, zinc, etc. In some embodiments, a material is described as brittle if it has a hardness that is higher than a neighboring material and a fracture toughness that is lower than the neighboring material. For example, metals, such as, aluminum (Al), iron (Fe), titanium (Ti), stainless steel, steel, steel alloys, copper (Cu), copper alloys, copper-steel alloys, may be described as brittle when surrounded by a material having a lower hardness and higher fracture toughness, such as a polymer material or a fiber reinforced composite material.

As used herein, the term “hardness” refers to a material property indicative of a material's resistance to localized plastic deformation, indentation, scratching, abrasion, cutting, or penetration under an applied force. Hardness may be characterized using any suitable scale or test method, including, for example, Mohs hardness, Vickers hardness (HV), Knoop hardness (HK), Brinell hardness (HB or HBW), Rockwell hardness (e.g., HRA, HRB, HRC), Shore hardness (e.g., Shore A or Shore D), or instrumented indentation hardness.

As discussed above, ceramic materials have many uses due to the many beneficial properties of ceramic materials. However, ceramic materials are also brittle. Thus, while ceramic materials can be used in many products and for many different purposes, the ceramic materials are easily damaged when exposed to extreme environments, such as high dynamic stress and thermal loads. Surrounding the ceramic materials with a secondary structure that is more resilient to stresses that may damage the ceramic materials may facilitate the formation of structures (e.g., composite structures) having the benefits of a ceramic material, while being resistant to damage. Embodiments of the disclosure include multiple different types of composite ceramic structures and methods of making the composite ceramic structures.

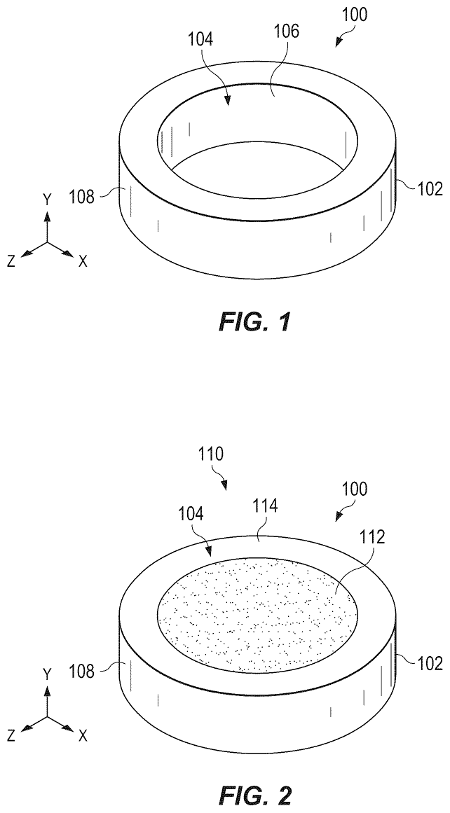

FIGS. 1-4 illustrate stages for forming a composite structure 400. The formation of the composite structure 400 may begin with a composite base structure 100. FIG. 1 illustrates the composite base structure 100. The composite base structure 100 may be formed from composite fibers (e.g., carbon fibers, glass fibers, silicon carbide fibers, etc.) within a sinterable matrix material, such as graphite, titanium, etc. In some embodiments, the matrix material may include ceramic materials, such as silicon carbide, boron carbide, boron nitride, silicon nitride, etc.

The composite base structure 100 illustrated in FIG. 1 is formed in an annular shape, forming a ring 102 defining a cavity 104 within the ring 102. In other embodiments, the composite base structure 100 may have more complex shapes. For example, the ring 102 may have non-circular shapes, such as rectangular shapes, triangular shapes, hexagonal shapes, etc. In some embodiments, the composite base structure 100 includes internal structures, such as internal trusses passing through the cavity 104, subdividing the cavity 104. Processes, such as additive manufacturing, fiber steering, etc., may be used to form the composite base structures 100 having complex shapes and structures.

The cavity 104 is defined, at least in part, by an inner surface 106 of the ring 102 of the composite base structure 100. An outer surface 108 of the ring 102 defines an outer perimeter of the composite base structure 100, which defines an outer perimeter of the composite structure 400 after the composite structure 400 is formed. In some embodiments, the outer surface 108 defines complementary shapes to other composite base structures 100, such that multiple composite structures 400 may be combined to form a larger composite structure after each individual composite structure 400 is formed.

After the composite base structure 100 is formed, the cavity 104 may be filled with a base material 112 to form a base assembly 110. The base material 112 is a powder that is configured to form a high hardness material (e.g., a material having a higher hardness than the composite structure resulting from the composite base structure 100) after sintering, such as a ceramic material, a metal material, etc. For example, the base material 112 may include, but is not limited to, silicon carbide (SiC), boron carbide (B₄C), titanium carbide (TiC), tungsten carbide (WC), alumina (Al₂O₃), zirconia (ZrO₂), silica (SiO₂), magnesia (MgO), lime (CaO), silicon nitride (Si₃N₄), etc. In other examples, the base material 112 may be a metal or metal alloy, such as aluminum (Al), iron (Fe), titanium (Ti), stainless steel, steel, steel alloys, copper (Cu), copper alloys, copper-steel alloys, etc. Powder forms of the base material 112 may be commercially available from numerous sources.

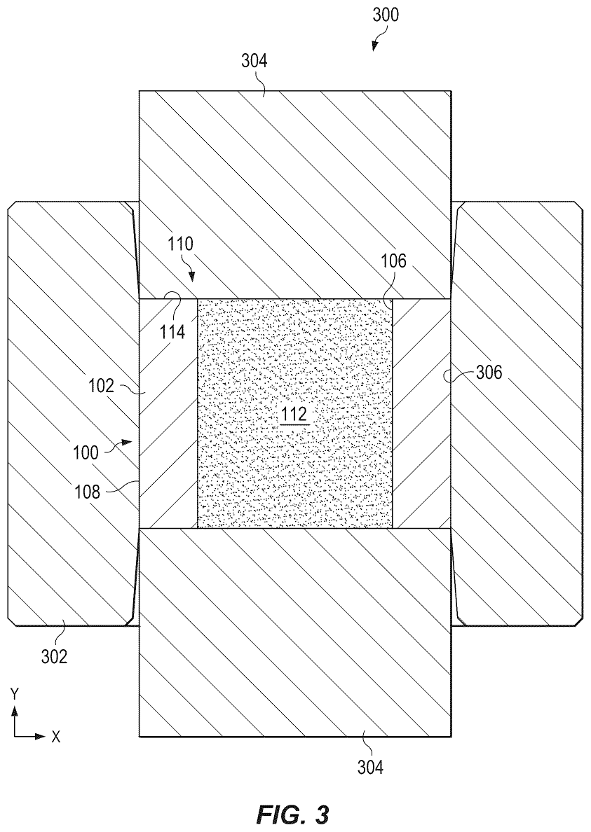

The base material 112 is positioned to substantially fill the cavity 104 within the ring 102 of the composite base structure 100, such that the base material 112 covers the inner surface 106 and any additional structures of the composite base structure 100 extending through the cavity 104. As illustrated in FIG. 2, the cavity 104 is filled with the base material 112 until the base material 112 is substantially level (e.g., co-planar) with an upper surface 114 of the composite base structure 100.

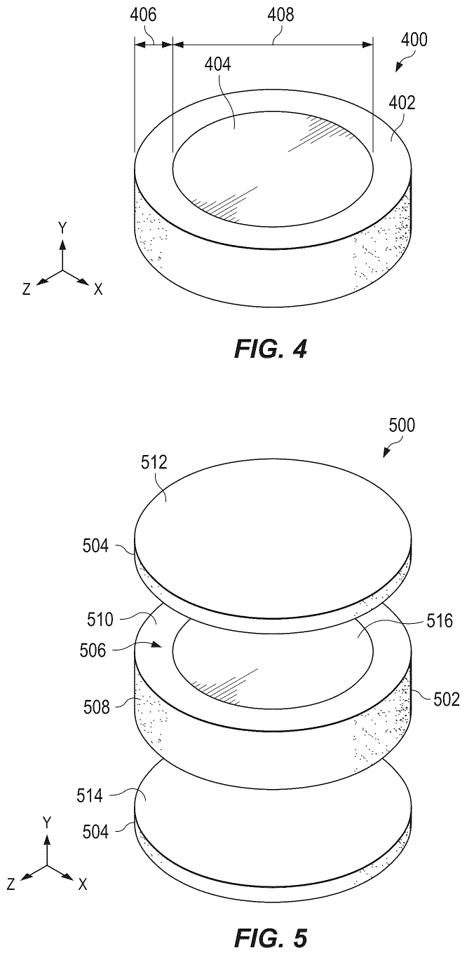

FIG. 3 illustrates a sintering assembly 300 that may be used to form the composite structure 400 through a sintering process. The sintering assembly 300 is configured to heat the base assembly 110, including both the composite base structure 100 and the base material 112, while also applying a pressure to the base assembly 110 to form a solid structure. In some embodiments, the sintering assembly 300 is an electric field assist sintering (EFAS) assembly configured to apply a pressure to the base assembly 110 while heating the base assembly 110 and sintering assembly 300 through an electric current passing through the sintering assembly 300 and the base assembly 110. In other embodiments, the sintering assembly 300 may be a hot press sintering assembly where the sintering assembly is heated externally, such as through inductive heating, resistance heating, etc.

The sintering assembly 300 may include a mold 302 and at least one ram 304 defining a cavity 306 configured to receive the base assembly 110. The at least one ram 304 is configured to apply pressure to the base assembly 110 in the cavity 306 of the sintering assembly 300. In the embodiment illustrated in FIG. 3, the sintering assembly 300 includes two opposing rams 304 positioned on opposing sides of the cavity 306 and configured to apply a pressure to the base assembly 110 in the cavity 306 defined in the mold 302 and between the two rams 304. In an EFAS assembly, a voltage is applied between the two rams 304 to induce an electric current from the first ram 304, through the mold 302 and the base assembly 110 in the cavity 306, and out the second ram 304. The electrical current passing through the mold 302 and the base assembly 110 in the cavity 306 generates heat in the mold 302 and the base assembly 110 in the cavity 306 based on the resistance of the materials of the mold 302, the composite base structure 100, and the base material 112 of the base assembly 110 in the cavity 306 to the electrical current. In other embodiments, the composite base structure 100 may act as the mold 302, such that the sintering assembly 300 does not include an additional mold 302 but applies pressure to the base assembly 110 including the composite base structure 100 and the base material 112 positioned within the cavity 104 of the composite base structure 100.

During the sintering process, the temperature of the base assembly 110 is raised to a sintering temperature of the composite base structure 100 and/or the base material 112. The sintering temperature is less than the melting temperature of the materials being sintered but high enough that the individual particles in the powdered or granulated materials coalesce (e.g., fuse) together under pressure to form the solid structure. The material of the composite base structure 100 may be selected to have a sintering temperature range that overlaps with a sintering temperature range of the base material 112, such that both the composite base structure 100 and the base material 112 may be sintered in the same process within the sintering assembly 300. For example, the composite base structure 100 may be formed from carbon fibers or silicon carbide fibers in a matrix, such as silicon carbide, boron carbide, boron nitride, silicon nitride, graphite or silicon carbide that have similar sintering temperatures to a carbide ceramic material, such as silicon carbide (SiC), boron carbide (B₄C), titanium carbide (TiC), or tungsten carbide (WC), which may be used as the base material 112.

The ring 102 of the composite base structure 100 may be sized and shaped such that the outer surface 108 is substantially a same shape and size as the portion of the cavity 306 defined by the mold 302. In embodiments where the composite base structure 100 acts as the mold 302, ring 102 of the composite base structure 100 may be sized and shaped such that the outer surface 108 is substantially a same shape and size or a smaller shape and size relative to a contact area of the ram 304. As discussed above, the amount of base material 112 in the cavity 104 defined by the ring 102 may be sufficient so that an upper surface of the base material 112 may be substantially coplanar with the upper surface 114 of the ring 102. When the rams 304 apply pressure to the base assembly 110, the pressure is distributed across the upper surface 114 of the ring 102 and the upper coplanar portion of the base material 112, such that similar pressure is applied to both the composite base structure 100 and the base material 112.

While the pressure is being applied by the rams 304 and the base assembly 110 is being heated, the matrix of the composite base structure 100 coalesces (e.g., fuses) with the fibers to form a rigid fiber reinforced outer structure and the base material 112 coalesces (e.g., fuses) together to form an associated solid core structure. The heat and pressure may also form bonds between the composite base structure 100 and the base material 112. In some embodiments, an optional reaction layer or reaction material is included between the inner surface 106 of the ring 102 and the base material 112. The reaction layer or reaction material (not shown) may be configured to form chemical bonds between the fiber reinforced composite of the composite base structure 100 and the base material 112.

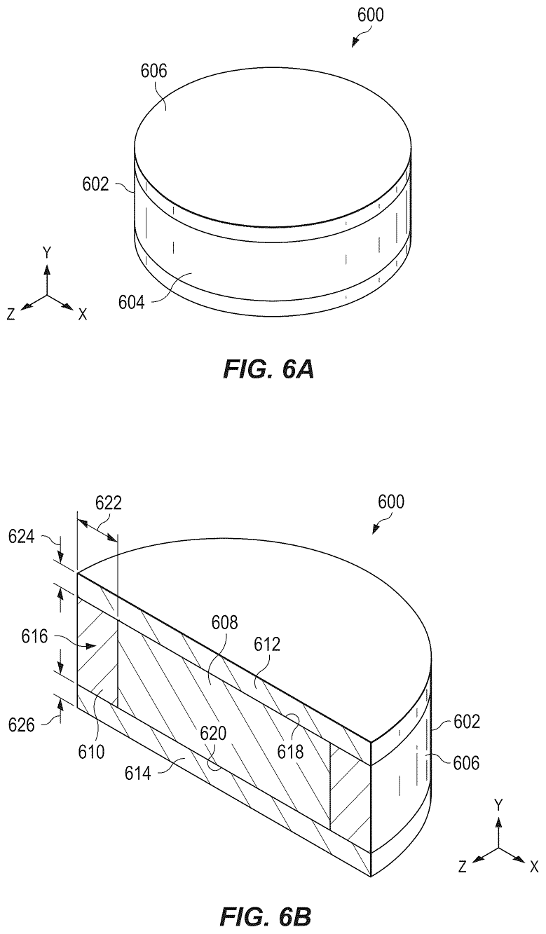

After the base assembly 110 is sintered, a composite structure 400 is formed, as illustrated in FIG. 4. The composite structure 400 includes a fiber reinforced composite ring 402 and a solid core 404 within the fiber reinforced composite ring 402. The fiber reinforced composite ring 402 is a rigid structure formed from the fibers of the ring 102 of the composite base structure 100 and the solidified matrix material. For example, the fiber reinforced composite ring 402 may be formed from a carbon-carbon composite, a carbon fiber composite, a silicon carbide fiber composite, etc. The solid core 404 is a rigid structure formed from the solidified (e.g., sintered) powdered base material 112. Thus, the solid core 404 may be a ceramic structure or a metal structure depending on the type of base material 112 used.

The fiber reinforced composite ring 402 has a radial thickness 406 that is substantially less than a major dimension 408 (e.g., diameter, radius, apothem, width, etc.) of the solid core 404. For example, the radial thickness 406 of the fiber reinforced composite ring 402 may be in a range from about 1% of the major dimension 408 to about 20% of the major dimension 408, such as from about 1% of the major dimension 408 to about 10% of the major dimension 408. In some embodiments, the radial thickness 406 of the fiber reinforced composite ring 402 may be in a range from about 2 mm (about 0.08 in) to about 25 mm (about 0.98 in), such as from about 2 mm (about 0.08 in) to about 13 mm (about 0.51 in).

The radial thickness 406 and the relationship between the radial thickness 406 and the major dimension 408 may vary based on the materials of the fiber reinforced composite ring 402 and the solid core 404 and/or the size of the composite structure 400. For example, as the major dimension 408 of the solid core 404 increases, the radial thickness 406 of the fiber reinforced composite ring 402 may not increase proportionally (e.g., at the same percentage). In some embodiments, the radial thickness 406 of the fiber reinforced composite ring 402 may remain constant across multiple different sizes of the solid core 404, such that the percentage size difference between the radial thickness 406 of the fiber reinforced composite ring 402 and the major dimension 408 of the solid core 404 decreases as the major dimension 408 of the solid core 404 increases.

As discussed above, ceramics and high hardness metal materials may be brittle or have a low fracture toughness. A fiber reinforced composite structure 400 may be more resilient to fracture at least due to the tensile strength of the fibers. With the fiber reinforced composite ring 402 radially surrounding the solid core 404, the fiber reinforced composite ring 402 may hold the solid core 404 together even if the solid core 404 fractures, such as due to an impact or other event. Fiber reinforced composites may also have a higher elastic modulus, such that a large impact that may fracture the solid core 404 will not fracture the fiber reinforced composite ring 402, such that the fiber reinforced composite ring 402 may function as a high strength, low density outer shell that contains the solid core 404, even if the solid core 404 fractures. By maintaining the solid core 404 together (e.g., any fragments in close proximity to one another), the solid core 404 may continue to provide the material benefits of the material of the solid core 404, such as insulative properties or shielding properties, as discussed above. In some embodiments, the fiber reinforced composite ring 402 may apply a radially inward compressive force on the solid core 404, which may further increase a fracture toughness of the material of the solid core 404. For example, by applying a ring of high tensile strength and high elastic modulus material around a ceramic core, compressive stress can be applied to the ceramic whereby fracture toughness against dynamic impacts will be improved by 20-30 percent. In some embodiments, the fiber reinforced composite structure may fully encapsulate the solid core 404.

Fiber reinforced composites have lower density than other materials that have similar tensile strengths. Therefore, surrounding a low density high hardness material, such as a ceramic material with a fiber reinforced composite may increase the fracture toughness of the low density high hardness material without substantially increasing the density of the combined structure. Therefore, the weight of the combined structure may remain low, which may facilitate its implementations into applications where weight is a larger concern, such as space craft, aircraft, and other lightweight applications. For example, lightweight carbon-carbon (C—C) materials applied around a ceramic material will create a composite with an improved mass efficiency as the overall composite density will be below that of ceramic core itself by 30 percent or more.

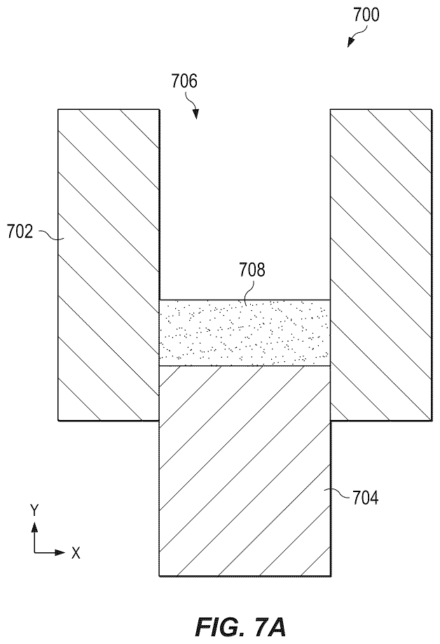

FIG. 5 illustrates a base assembly 500 for forming a composite structure with a rigid core encapsulated in a fiber reinforced composite. The base assembly 500 includes a base composite ring 502 and two base composite lids 504 on opposing axial ends of the base composite ring 502. The base composite ring 502 and the base composite lids 504 may be formed from composite fibers (e.g., carbon fibers, glass fibers, silicon carbide fibers, etc.) within a sinterable matrix material, such as silicon carbide, boron carbide, boron nitride, silicon nitride, graphite, titanium, etc.

The base composite ring 502 illustrated in FIG. 5 is formed in an annular structure defining a cavity 506 within the base composite ring 502. In other embodiments, the base composite ring 502 may have a more complex shape. For example, the base composite ring 502 may have a non-circular shape, such as a rectangular shape, a triangular shape, a hexagonal shape, etc. The base composite ring 502 may also include internal structures, such as internal trusses passing through the cavity 506, subdividing the cavity 506. Processes, such as additive manufacturing, fiber steering, etc., may be used to form the base composite ring 502 having complex shapes and structures.

The cavity 506 of the base composite ring 502 may be filled with a base material 516. The base material 516 may be configured to form a high hardness material (e.g., a material having a higher hardness than the composite structure resulting from the base composite ring 502) after sintering, such as a ceramic material, a metal material, etc. For example, the base material 516 may include, but is not limited to, silicon carbide (SiC), boron carbide (B₄C), titanium carbide (TiC), tungsten carbide (WC), alumina (Al₂O₃), zirconia (ZrO₂), silica (SiO₂), magnesia (MgO), lime (CaO), silicon nitride (Si₃N₄), etc. In other examples, the base material 516 may be a powdered metal or metal alloy, such as aluminum (Al), iron (Fe), titanium (Ti), stainless steel, steel, steel alloys, copper (Cu), copper alloys, copper-steel alloys, etc. Powder forms of the base material 112 may be commercially available from numerous sources.

The base material 516 is positioned to substantially fill the cavity 506 within the base composite ring 502. As illustrated in FIG. 5, the cavity 506 is filled with the base material 516 until the base material 516 is substantially level (e.g., co-planar) with an upper surface 510 of the base composite ring 502. The base composite lids 504 are positioned over and under the cavity 506 of the base composite ring 502, enclosing the cavity 506 and the base material 516 therein. The base material 516 may be in direct contact with inner surfaces 514 of the base composite lids 504. The inner surface 514 of the upper base composite lid 504 may also be in direct contact with the upper surface 510 of the base composite ring 502 when fully assembled. Similarly, the inner surface 514 of the lower base composite lid 504 may be in direct contact with a bottom surface of the base composite ring 502 when fully assembled. Thus, the base composite lids 504 define upper and lower bounds for the cavity 506.

A radially outer surface 508 of the base composite ring 502 defines an outer shape of the base assembly 500. The base composite lids 504 may have a substantially similar shape as the shape defined by the radially outer surface 508 of the base composite ring 502, such that, when assembled, the base assembly 500 has a substantially constant radially outer surface 508 between axial outer surfaces 512 of the base composite lids 504.

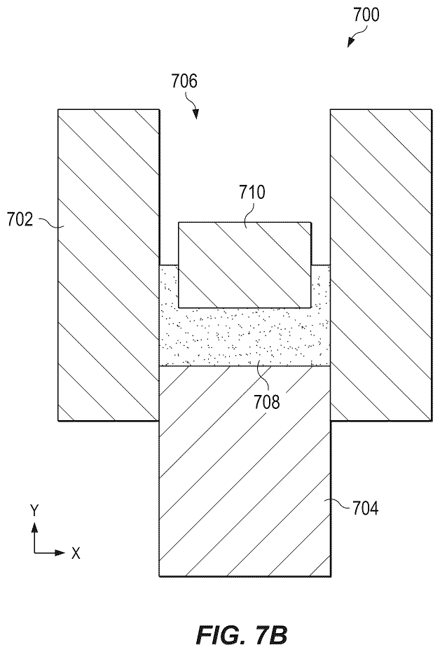

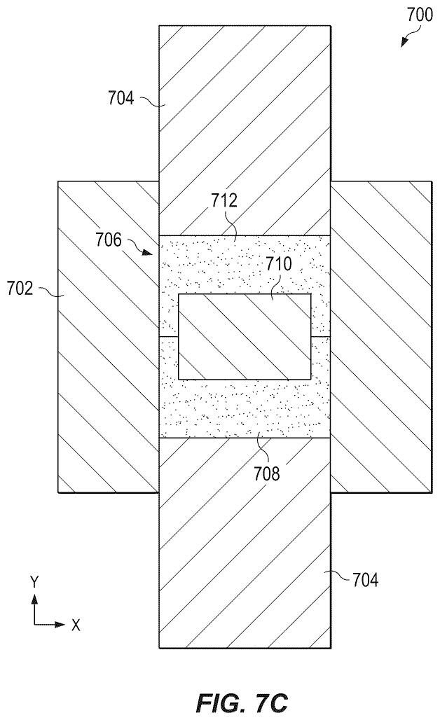

After the base assembly 500 is assembled, the base assembly 500 is sintered by applying a high pressure and temperature to the base assembly 500, such as through the sintering assembly 300 discussed above. FIGS. 6A and 6B illustrate a composite structure 600 formed from the base assembly 500 after sintering the base assembly 500. FIG. 6A illustrates a perspective view of the composite structure 600 and FIG. 6B illustrates a sectional view of the composite structure 600.

The composite structure 600 includes a fiber reinforced composite shell 602 formed from the sintered base composite ring 502 and base composite lids 504. During the sintering process, the base composite ring 502 and the base composite lids 504 fuse together to form the fiber reinforced composite shell 602 as a single structure. Thus, the fiber reinforced composite shell 602 is a monolithic structure. The fiber reinforced composite shell 602 includes a radially outer surface 604 that substantially corresponds to the radially outer surface 508 of the base assembly 500 and axial outer surfaces 606 that substantially correspond to the outer surfaces 512 of the base composite lids 504.

The fiber reinforced composite shell 602 surrounds a core 608. The core 608 is a rigid structure formed from the solidified powdered base material 516. Thus, the core 608 may be a ceramic structure or a metal structure depending on the type of base material 516 used. The fiber reinforced composite shell 602 includes a fiber reinforced side wall 610 corresponding to the base composite ring 502, a fiber reinforced upper wall 612 corresponding to the upper base composite lid 504, and a fiber reinforced lower wall 614 corresponding to the lower base composite lid 504. The fiber reinforced side wall 610 surrounds a side wall 616 of the core 608. The fiber reinforced upper wall 612 is positioned against an upper surface 618 of the core 608. The fiber reinforced lower wall 614 is positioned against a lower surface 620 of the core 608. Thus, each surface of the core 608 contacts (e.g., rests against) a portion of the fiber reinforced composite shell 602. Because the fiber reinforced composite shell 602 is a monolithic structure, no hardware is used to secure the fiber reinforced side wall 610 to the fiber reinforced upper wall 612 or the fiber reinforced lower wall 614.

In some embodiments, a thickness 622 of the fiber reinforced side wall 610 in a radial direction (e.g., an X-direction or a Z-direction) is greater than a thickness 624 of the fiber reinforced upper wall 612 in a vertical direction (e.g., a Y-direction) or than a thickness 626 of the fiber reinforced lower wall 614 in the vertical direction. In some embodiments, the thickness 624 of the fiber reinforced upper wall 612 and the thickness 626 of the fiber reinforced lower wall 614 are substantially the same. In other embodiments, the thickness 624 of the fiber reinforced upper wall 612 and the thickness 626 of the fiber reinforced lower wall 614 may be different. In some embodiments, the thicknesses 622, 624, 626 of the fiber reinforced side wall 610, the fiber reinforced upper wall 612, and the fiber reinforced lower wall 614 are substantially the same, such that the fiber reinforced composite shell 602 has a substantially uniform thickness throughout the fiber reinforced composite shell 602.

As discussed above, the core 608 may be a material that is brittle or has a low fracture toughness. The fiber reinforced composite shell 602 may be more resilient to fracture at least due to the tensile strength of the fibers. With the fiber reinforced composite shell 602 surrounding the core 608, the fiber reinforced composite shell 602 may hold the core 608 together even if the core 608 fractures, such as due to an impact or other event. By maintaining the core 608 together, the core 608 may continue to provide the material benefits of the material of the core 608, such as insulative properties or shielding properties, as discussed above. In embodiments, such as the composite structure 600 illustrated in FIG. 6, where the fiber reinforced composite shell 602 fully encapsulates the core 608, any pieces of the core 608 that are formed upon an impact are less likely to be lost if the core 608 is fractured, at least due to the monolithic fiber reinforced composite shell 602 encapsulating the core 608. In some embodiments, the fiber reinforced composite shell 602 may apply a radially inward compressive force on the core 608, which may further increase a fracture toughness of the material of the core 608. For example, compressive stress can be applied to the ceramic by applying a high tensile strength and high elastic modulus material around the ceramic core, whereby fracture toughness against dynamic impacts will be improved by 20-30 percent.

Fiber reinforced composites have lower density than other materials that have similar tensile strengths. Therefore, surrounding a low density high hardness material, such as a ceramic material with a fiber reinforced composite may increase the fracture toughness of the low density high hardness material without substantially increasing the density of the combined structure. Therefore, the weight of the combined structure may remain low, which may facilitate its implementations into applications where weight is a larger concern, such as space craft, aircraft, and other lightweight applications. For example, lightweight carbon-carbon (C—C) materials applied around a ceramic material will create a composite with an improved mass efficiency as the overall composite density will be below that of ceramic core itself by 30 percent or more.

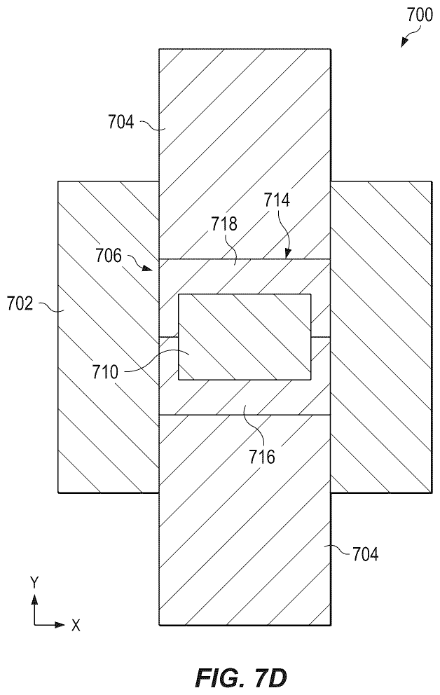

In some embodiments, the materials of the core (e.g., the solid core 404 or the core 608) and the surrounding structure (e.g., the fiber reinforced composite ring 402 or the fiber reinforced composite shell 602) may have different sintering temperatures. Thus, to form solid structures from both materials at least one of the materials may be sintered separately. FIG. 7A-7D illustrate stages of a process of forming a composite structure from a base material and a solid core structure with a sintering assembly 700, where the solid core is sintered in a separate act.

In FIG. 7A, a first base material 708 is disposed in a cavity 706 of the sintering assembly 700. The cavity 706 is defined by a mold 702 extending radially about the cavity 706 and a ram 704 or base defining a bottom vertical boundary of the cavity 706. The first base material 708 may be a sinterable material, such as a sinterable composite material (e.g., a fiber reinforced composite material, a composite matrix material, etc.) or a sinterable metal material (e.g., aluminum (Al), iron (Fe), titanium (Ti), stainless steel, steel, steel alloys, copper (Cu), copper alloys, copper-steel alloys, etc.). The first base material 708 may be deposited in a powdered or other particulate form that may conform to the shape of the cavity 706 defined by the mold 702 and the ram 704.

After depositing the first base material 708 in the cavity 706, a core structure 710 is positioned over the first base material 708. The core structure 710 may be a solid structure, such as a ceramic structure or a metallic structure, formed through a separate process, such as a separate sintering process. For example, the material of the core structure 710 may have a sintering temperature that is much higher than the sintering temperature of the first base material 708, such as greater than a melting temperature of the first base material 708. Forming the core structure 710 in a separate process may facilitate performing the sintering of the full composite structure at a temperature that is less than the sintering temperature of the core structure 710.

As illustrated in FIG. 7B, the core structure 710 is positioned within the first base material 708, such that the core structure 710 displaces some of the first base material 708 and the first base material 708 extends along a portion of the sides of the core structure 710. After displacing some of the first base material 708, the first base material 708 at least partially envelops the core structure 710. As illustrated in FIG. 7B, the core structure 710 is positioned such that a space remains circumferentially about the core structure 710 between the core structure 710 and the mold 702. The first base material 708 may at least partially fill the space, such that the first base material 708 is positioned radially between the core structure 710 and the mold 702 circumferentially about the core structure 710.

After disposing the core structure 710 into the cavity 706, a second base material 712 is disposed into the cavity 706 over the core structure 710 and the first base material 708. In some embodiments, the second base material 712 is the same material composition as the first base material 708. In other embodiments, the second base material 712 may be a different material composition from the first base material 708. If the second base material 712 is different from the first base material 708, the first base material 708 and the second base material 712 are selected to have overlapping sintering temperatures.

The second base material 712 is disposed into the cavity 706 in a powdered or particulate form similar to the first base material 708. The second base material 712 conforms to the space remaining in the cavity 706, such that the second base material 712 extends around the core structure 710 further enveloping the core structure 710 by filling the spaces that do not contain the first base material 708. Thus, the second base material 712 and the first base material 708 combine to fill the space radially between the core structure 710 and the mold 702 circumferentially about the core structure 710.

In some embodiments, interfacing materials, such as a reaction layer or reaction material are optionally positioned between one or more of the materials, such as between the core structure 710 and both the first base material 708 and the second base material 712 or between the first base material 708 and the second base material 712. The interfacing materials may be configured to promote chemical bonding across the interfaces during the sintering process. In embodiments where the first base material 708 and the second base material 712 are formed from the same material, no interfacing materials are included between the first base material 708 and the second base material 712. However, an interfacing material may still be included between at least one of the first base material 708 or the second base material 712 and the core structure 710.

After the first base material 708, the core structure 710, and the second base material 712 are disposed in the cavity 706, the rams 704 apply a pressure to the cavity 706 while the materials in the cavity 706 are heated, such as through an electrical current or an inductive heater. The materials in the cavity 706 are heated to a sintering temperature of the first base material 708 and the second base material 712. As discussed above, the sintering temperature of the first base material 708 and the second base material 712 may be less than a sintering temperature of the material of the core structure 710.

Heating the first base material 708 and the second base material 712 to the sintering temperature while applying pressure to the cavity 706 through the rams 704 causes the particles of the first base material 708 and the second base material 712 to fuse together to form a first structure 716 and a second structure 718, respectively, as illustrated in FIG. 7D. The first structure 716, the second structure 718, and the core structure 710 combine to form a composite structure 714. The first structure 716 and the second structure 718 are also fused together, such that the composite structure 714 includes a substantially monolithic outer structure similar to the fiber reinforced composite shell 602 described above with respect to FIGS. 6A and 6B. In embodiments where the first base material 708 and the second base material 712 are the same material composition, the first base material 708 and the second base material 712 fuse together such that the first structure 716 and the second structure 718 are a monolithic solid structure formed from the same material of the first base material 708 and the second base material 712.

The materials of the first structure 716 and the second structure 718 may have a higher coefficient of thermal expansion than the materials of the core structure 710. For example, the core structure 710 may be formed from a ceramic material and the first structure 716 and the second structure 718 may be formed from a metallic material. As the composite structure 714 cools after the sintering process, the higher coefficient of thermal expansion of the outer structure formed from the first structure 716 and the second structure 718 may cause the first structure 716 and the second structure 718 to shrink a greater amount than the core structure 710. Thus, the first structure 716 and the second structure 718 may impart a compressive force onto the core structure 710 from multiple (e.g., all) directions. The compressive force may increase a fracture toughness of the core structure 710. As discussed above, this decreases the brittleness of the highly brittle material of the core structure 710. For example, as discussed above, compressive stress can be applied to the ceramic through a surrounding material whereby fracture toughness against dynamic impacts will be improved by 20-30 percent. Furthermore, the encapsulation of the core structure 710 within the first structure 716 and the second structure 718 may hold the core structure 710 together even if the core structure 710 is fractured.

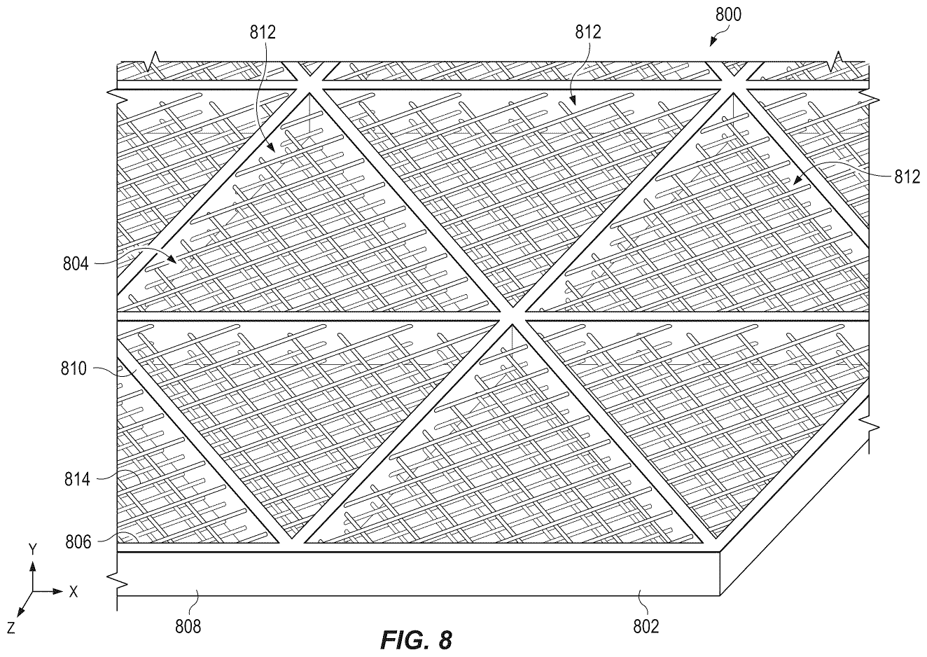

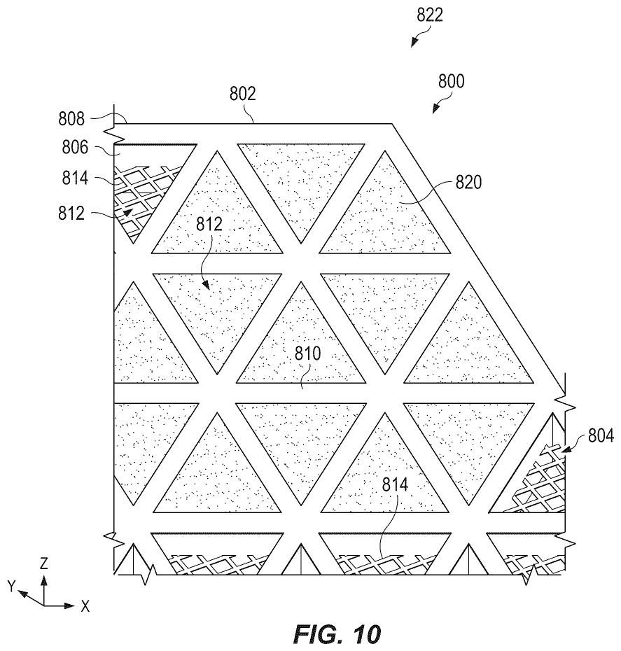

FIGS. 8-10 illustrate views of a composite base structure 800. As discussed above, the composite base structure 800 may be formed with complex geometries through an additive manufacturing process, such as 3-D printing or fiber steering. FIG. 8 illustrates an enlarged view of a portion of the composite base structure 800. The composite base structure 800 includes a ring 802 defining an outer boundary of the composite base structure 800 and a cavity 804 within the ring 802. The ring 802 includes an inner surface 806 facing the cavity 804 and an outer surface 808 facing away from the cavity 804. In the embodiment illustrated in FIG. 8, the ring 802 has a hexagonal shape.

The composite base structure 800 includes multiple intermediate structures 810 extending into the cavity 804 from the inner surface 806 of the ring 802. In the embodiment illustrated in FIG. 8, the intermediate structures 810 have a width and height that are substantially the same as a width and height of the ring 802. The intermediate structures 810 intersect one another within the cavity 804, subdividing the cavity 804 into smaller sub-sections 812. In the embodiment illustrated in FIG. 8, the intermediate structures 810 define triangular sub-sections 812 within the cavity 804.

In some embodiments, additional intermediate supports 814 extend through the cavity 804 between the intermediate structures 810 and/or the inner surface 806 of the ring 802. The intermediate supports 814 may have cross-sectional dimensions (e.g., width and height) that are less than those of the ring 802 and the intermediate structures 810, such that the intermediate supports 814 do not further divide the sub-sections 812 defined by the intermediate structures 810.

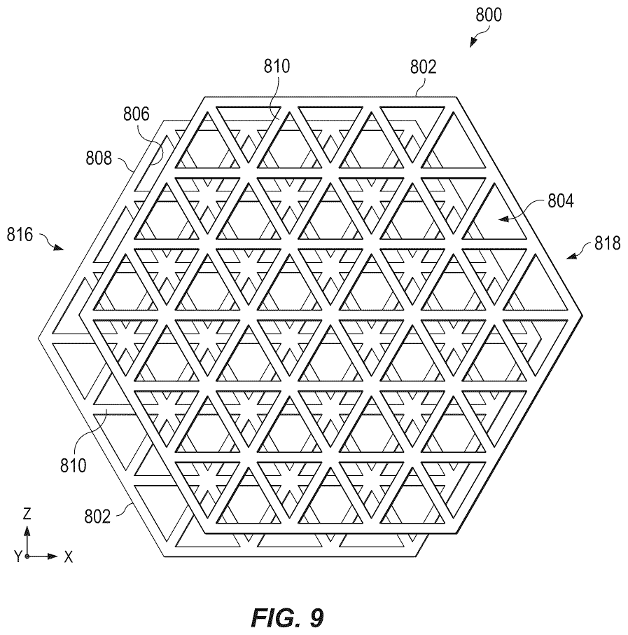

In some embodiments, the composite base structure 800 is formed from two vertically offset structures 816, 818, as illustrated in FIG. 9. The composite base structure 800 includes a first structure 816 and a second structure 818. The first structure 816 and the second structure 818 are vertically offset from one another, such that the second structure 818 is positioned vertically above (e.g., in the Y-direction) the first structure 816. The first structure 816 and the second structure 818 are also offset in both lateral directions (e.g., the X-direction and the Z-direction), such that the ring 802 and the intermediate structures 810 of the second structure 818 substantially vertically overlie the open sub-sections 812 of the cavity 804 of the first structure 816. The first structure 816 and the second structure 818 may be connected to each other at each intersection of the rings 802 or intermediate structures 810.

While not illustrated in FIG. 9 for simplicity, the sub-sections 812 may each include the intermediate supports 814 (FIG. 8) passing through for additional support between the intermediate structures 810 and the rings 802 as discussed above. In some embodiments, the composite base structure 800 is formed from composite fibers (e.g., carbon fibers, glass fibers, silicon carbide fibers, etc.) within a sinterable matrix material, such as silicon carbide, boron carbide, boron nitride, silicon nitride, graphite, titanium, etc. The composite base structure 800 may be configured to be solidified in a subsequent sintering act as discussed above.

Each open sub-section 812 of the composite base structure 800 may be subsequently filled with a core base material, such as a ceramic powder. The core base material may pass around the intermediate structures 810 and intermediate supports 814 to substantially fill all available open areas (e.g., spaces) within the cavity 804. In embodiments, such as the composite base structure 800 illustrated in FIG. 9, the core base material may pass under the intermediate structures 810 and ring 802 of the second structure 818 to substantially fill the open areas of the cavity 804 of the first structure 816 including the areas under the intermediate structures 810 and the ring 802 of the second structure 818. The composite base structure 800 and the ceramic powder may then be sintered to form a rigid composite structure 822 having core structures 820 in each of the sub-sections 812 of the cavity 804.

Composite structures 822 are formed from embodiments of the composite base structure 800 including offset first structures 816 and second structures 818, such as the composite base structure 800 illustrated in FIG. 9. The intermediate structures 810 and the ring 802 of the second structure 818 are vertically overlying the core structures 820 of the first structure 816, and the core structures 820 of the second structure 818 are vertically overlying the intermediate structures 810 and the ring 802 of the first structure 816. As discussed above, the core structures 820 may perform multiple different desirable functions, such as shielding capabilities, impact absorption, insulation, etc. These same functions may not be performed by the supportive materials of the composite base structure 800. Thus, by laterally offsetting the first structure 816 and the second structure 818, the horizontal area of the total composite structure 822 without core structures 820 is substantially reduced, which may increase the shielding, impact absorption, and/or insulation capabilities of the composite structure 822.

Embodiments of the disclosure may facilitate the construction of composite structures including brittle materials surrounded by supportive materials. The supportive materials may increase the fracture toughness of the brittle materials and/or may maintain the brittle materials in substantially a same shape and position if the brittle materials fracture. Some brittle materials, such as ceramic materials, may be used to perform desirable functions, such as shielding functions, insulating functions, impact absorption functions, etc. Surrounding the brittle materials with the supportive materials may facilitate increased reliability of the brittle materials, such as by increasing fracture toughness of the brittle materials and maintaining brittle materials in substantially a same position and arrangement if fractured. Thus, surrounding the brittle materials by the supportive materials may enable the composite structures to resist fracture for a longer period of time and continue to perform the desired function even after being fractured. The composite structures may also maintain their integrity when subjected to multiple impacts or other events.

The composite structures may be used in various applications where durable and light weight articles including the composite structure are desired. The composite structure may, for example, function as a radiation barrier and/or a kinetic barrier. The articles may also be resilient to extreme environmental conditions. The composite structures may exhibit increased fracture toughness, an improved mass efficiency (i.e., as an overall composite density will be below that of the core itself), and increased impact survivability compared to conventional structures. The composite structures may be used as shielding in extreme environments, such as radiation shielding in a nuclear reactor or thermal shielding and/or impact shielding on a space craft.

In some embodiments, the composite structures may form hybrid structures utilizing the properties of the different materials for different functions. For example, the tensile strength of the outer supporting structure may facilitate forming structural components, such as beams or rods, while the brittle core materials may perform the shielding functions described above. Thus, the combination may facilitate a reduction in components in an associated structure or vehicle while maintaining the functionality of the structural and shielding components. The reduction in components may result in a reduction in volume, weight, and/or complexity of the associated structure or vehicle.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the present disclosure, in addition to those shown and described herein, such as alternative useful combinations of the elements described, may become apparent to those skilled in the art from the description. Such modifications and embodiments are also intended to fall within the scope of the appended claims and their legal equivalents.

What is claimed is:

1. A composite structure comprising:
a first brittle core material;
a fiber reinforced composite material radially surrounding the first brittle core material; and
a chemical bond between a radially outer surface of the first brittle core material and a radially inner surface of the fiber reinforced composite material.

2. The composite structure of claim 1, wherein the fiber reinforced composite material comprises carbon fibers.

3. The composite structure of claim 1, wherein the fiber reinforced composite material comprises a matrix material exhibiting a sintering temperature within a sintering temperature range of the first brittle core material.

4. The composite structure of claim 3, wherein the matrix material comprises a ceramic material.

5. The composite structure of claim 1, wherein the fiber reinforced composite material axially surrounds the first brittle core material.

6. The composite structure of claim 1, further comprising a second brittle core material adjacent the first brittle core material, the fiber reinforced composite material positioned between the first brittle core material and the second brittle core material.

7. The composite structure of claim 1, wherein the fiber reinforced composite material defines multiple subsections and a portion of the first brittle core material is disposed in each of the multiple subsections.

8. The composite structure of claim 7, further comprising intermediate supports extending through the portion of the first brittle core material in each of the multiple subsections.

9. The composite structure of claim 8, wherein the intermediate supports have intermediate cross-sectional dimensions that are less than a cross-sectional dimension of the fiber reinforced composite material radially surrounding the portion of the first brittle core material.

10. A method of forming a composite structure, the method comprising:
positioning an outer material in a cavity of a sintering device;
depositing an inner material in the outer material;
applying a pressure to the outer material and the inner material; and
heating the outer material and the inner material to a sintering temperature of at least one of the outer material and the inner material while applying the pressure, the inner material exhibiting a higher hardness than the outer material after applying the pressure and heating the outer material and the inner material.

11. The method of claim 10, wherein depositing the inner material comprises depositing a ceramic base material.

12. The method of claim 10, wherein depositing the inner material comprises depositing a sintered ceramic structure.

13. The method of claim 10, wherein depositing the outer material comprises depositing a pre-formed composite structure.

14. The method of claim 13, wherein depositing the pre-formed composite structure comprises:
forming the pre-formed composite structure through an additive manufacturing process; and
placing the pre-formed composite structure into the cavity.

15. The method of claim 10, wherein heating the outer material and the inner material to the sintering temperature comprises heating the outer material and the inner material to the sintering temperature within a sintering temperature range of the inner material and within a sintering temperature range of the outer material.

16. A method of forming a composite structure, the method comprising:
depositing a first base material powder into a cavity of a sintering assembly;
depositing a sintered ceramic structure over the first base material powder;
depositing a second base material powder over the sintered ceramic structure;
applying a pressure to the first base material powder, the sintered ceramic structure, and the second base material powder within the cavity; and
heating the first base material powder, the sintered ceramic structure, and the second base material powder within the cavity to a sintering temperature of the first base material powder and the second base material powder while applying the pressure.

17. The method of claim 16, wherein depositing the first base material powder comprises depositing a first base metal powder and wherein depositing the second base material powder comprises depositing a second base metal powder.

18. The method of claim 17, further comprising forming a monolithic metal structure from the first base metal powder and the second base metal powder, the monolithic metal structure surrounding the sintered ceramic structure.

19. The method of claim 16, wherein depositing the sintered ceramic structure comprises depositing the sintered ceramic structure formed from a material having a sintering temperature higher than the sintering temperature of the first base material powder and the second base material powder.

20. The method of claim 16, wherein heating the first base material powder, the sintered ceramic structure, and the second base material powder within the cavity to a sintering temperature of the first base material powder and the second base material powder while applying the pressure comprises heating the first base material powder, the sintered ceramic structure, and the second base material powder within the cavity to a temperature less than a sintering temperature of the sintered ceramic structure.
